(19) United States
(12) Patent Application Publication
(10) Pub. No.: US 2004/0085347 A1
(43) Pub. Date: May 6, 2004

(54) Storage area network management

(76) Inventors: Richard Hagarty JR., Roseville, CA (US); Eric D. Hubbard, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/284,752

(22) Filed: Oct. 31, 2002

(51) Int. Cl. G09G 5/00

(52) U.S. Cl. 345/735

(57) ABSTRACT

A computerized method for managing a storage area network (SAN) including a SAN manager associated with a storage area mapping (SAM) module. The method includes displaying, in a first window of a graphical user interface (GUI), any mapped devices, and displaying, in a second window of the GUI, any unmapped devices. A user can supplement a topology map selectively and incrementally, using inferred link information and/or user-supplied information to include additional devices in the map.

### BACKGROUND OF THE INVENTION

In a storage area network (SAN) for a business enterprise, high-speed, high-bandwidth connections typically are utilized to enable network servers to share storage arrays and/or storage devices. Network hardware and software are integrated to enhance network flexibility and performance. A business user, who typically has access to data storage areas in the SAN via a server, may require fast and reliable access to stored information. It is important, then, for those managing such a network to be able to keep track of and to change storage configurations easily, quickly and flexibly.

The plurality of devices integrated in a SAN, for example, fibre channel hubs, hosts, switches, storage devices and bridges, can be associated with one another not only physically, i.e. via hardware, but also logically, i.e. via software. It can be difficult for a network administrator to comprehend the frequently considerable complexities of a SAN configuration. Thus network management software typically provides for topology mapping, wherein all devices and connections of the network are sought to be discovered and displayed.

The management software collects information such as port numbers and types of switches to which a given network device is connected. The software can collect such data, for example, by using interfaces provided by device plug-ins (DPIs) and/or host bus adapter (HBA) libraries supported by the Storage Networking Industry Association (SNIA). When complete information about a link between two devices can be determined from such sources, the link is considered physical.

Fibre channel hubs, however, typically do not provide complete connection information and might not be “visible” to the management software. In the absence of complete connection data, and/or when a fibre channel hub is included in a network topology, logical or inferred links between two devices may be used. As recognized by the inventors hereof, a network administrator would find it useful to be able to view a topology map in which physically linked devices are shown, and to supplement the map selectively and incrementally with inferred link information and/or user-supplied information.

### SUMMARY OF THE INVENTION

In one embodiment, the invention is directed to a computerized method of managing a storage area network (SAN). The SAN includes a plurality of devices and a SAN manager associated with a storage area mapping (SAM) module that represents the devices and links between the devices. The method includes displaying, in a first window of a graphical user interface (GUI), any mapped devices. The method also includes displaying, in a second window of the GUI, any unmapped devices.

Further areas of applicability of the present invention will become apparent from the detailed description provided hereinafter. It should be understood that the detailed description and specific examples, while indicating certain embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of an apparatus for managing storage area networks (SANs) in accordance with one embodiment of the present invention;

FIG. 2 is an illustration of a graphical user interface in a physical map mode in accordance with one embodiment of the present invention;

FIG. 3 is a view of a map toolbar according to one embodiment;

FIG. 4 illustrates a map legend showing shapes, colors and line patterns used in one embodiment to graphically represent device types, device and link status, and link types;

FIG. 5 is an illustration of a graphical user interface displaying tooltips in accordance with one embodiment of the present invention;

FIG. 6A is a map in accordance with one embodiment of the present invention;

FIG. 6B is an illustration of objects associated with the map shown in FIG. 6A in accordance with one embodiment of the present invention;

FIG. 7 is an illustration of an add link dialog box according to one embodiment;

FIG. 8 is an illustration of an add link confirmation box according to one embodiment;

FIG. 9 is an illustration of a remove link dialog box according to one embodiment;

FIG. 10 is an illustration of a remove link confirmation box according to one embodiment;

FIG. 11 is an illustration of a move link dialog box according to one embodiment;

FIG. 12 is an illustration of a move link confirmation box according to one embodiment;

FIG. 13 is an illustration of an associate interconnect device dialog box according to one embodiment;

FIG. 14 is an illustration of an associate interconnect device confirmation box according to one embodiment;

FIG. 15 is an illustration of an associate with unknown device dialog box according to one embodiment;

FIG. 16 is an illustration of an associate with unknown device confirmation box according to one embodiment;

FIG. 17 is an illustration of a graphical user interface according to one embodiment, displaying two unknown devices in an upper window and a host in a lower window;

FIG. 18 is an illustration of an associate with unknown device dialog box according to one embodiment;

FIG. 19 is an illustration of a graphical user interface according to one embodiment, displaying an unknown device and a host in an upper window and the host in a lower window;

FIG. 20 is an illustration of an associate with unknown device dialog box according to one embodiment;

FIG. 21 is an illustration of a graphical user interface displaying a host in an upper window according to one embodiment;

FIG. 22 is an illustration of a graphical user interface in an inferred map mode in accordance with one embodiment of the present invention;

FIG. 23 is an illustration of an overview window displayed via a GUI according to one embodiment;

FIG. 24 is an illustration of a layout manager dialog box according to one embodiment; and

FIG. 25 is an illustration of a find node dialog box according to one embodiment.

### DETAILED DESCRIPTION OF THE INVENTION

The following description of embodiments of the present invention is merely exemplary in nature and is in no way intended to limit the invention, its application, or uses.

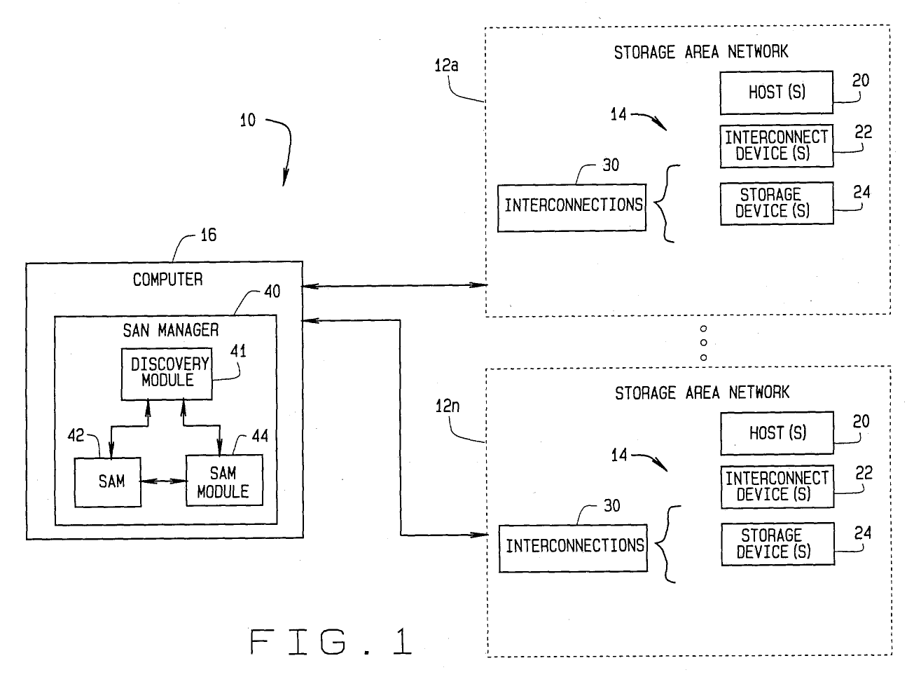

A storage area network (SAN) management apparatus in accordance with one embodiment of the present invention is indicated generally by reference number 10 in FIG. 1. One or more storage area networks (SANs) 12, indicated as 12a-12n in the present embodiment, respectively include one or more storage network devices 14. The SANs 12 are connected to a computer 16. The device(s) 14 can include one or more host(s) 20, interconnect device(s) 22, and/or storage device(s) 24. Interconnect device(s) 22 can include bridges, switches and hubs. The devices 14 of the SANs 12 are interconnected in a variety of ways. To simplify FIG. 1, the specific interconnections of the devices 14 of the SANs 12a-12n are generally labeled 30. Skilled artisans can appreciate that each device 14 can be connected to zero, one or more other devices 14.

The computer 16 includes a SAN manager 40 that is a computer program for managing the SANs 12. For example, Hewlett Packard Storage Area Manager software is a suitable SAN manager. Other SAN managers may be employed. The computer 16 includes a pointing and selecting device such as a keyboard and/or a mouse. For purposes of clarity, the following description will include a mouse. However, other input/output devices are contemplated.

A discovery module 41 automatically generates topology information based on data retrieved from the devices 14. The discovery module 41 employs, for example, standard protocols such as fibre channel, simple network management protocol (SNMP), small computer system interface (SCSI), and/or other suitable protocols. The data that is collected from the devices 14 is used to define links between the devices 14. The term “link” as used herein includes a representation, in a memory of the computer 16, of a physical or logical interconnection 30 between devices 14. “Link” also can include a representation, in a memory of the computer 16, of a user-defined interconnection between devices 14.

From the collected device and link data, storage area maps (SAMs) 42 are created by a SAM module 44. SAMs 42 are used to graphically illustrate direct and indirect links between devices 14 in the SAN 12. Two devices 14 are said to be indirectly linked when each is linked to a third device 14. As can be appreciated, the discovery module 41 and the SAM module 44 may be integrated with the SAN manager 40 or other components, including add-in components.

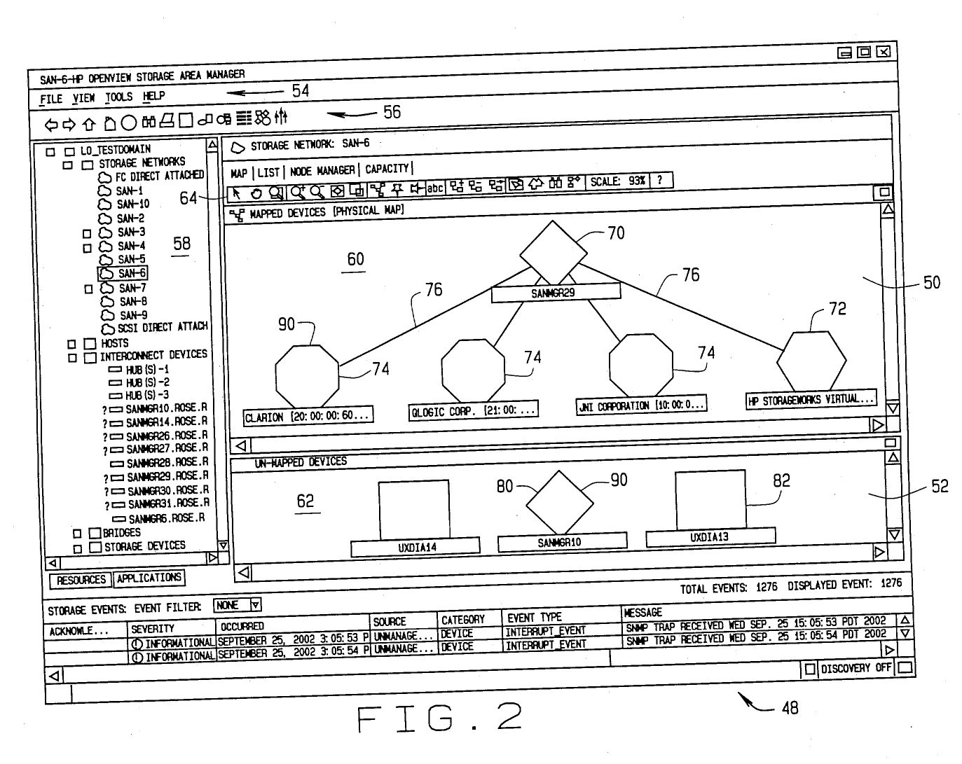

A graphical user interface (GUI) according to one embodiment of the apparatus 10 is indicated generally by reference number 48 in FIG. 2. When the GUI 48 is invoked in a physical map mode as shown in FIG. 2, the GUI 48 simultaneously displays first and second windows 50 and 52 that can operate independently of each other. A user, e.g., a network administrator, can use the GUI 48 in the physical map mode to view and selectively modify a storage area map 42 representing devices 14 and links therebetween.

The GUI 48 displays in the first window 50 any devices 14 mapped by the SAM module 44. A “mapped” device 14 includes a device 14 for which physical links have been discovered. The GUI 48 also displays, in the second window 52, any unmapped devices 14 discovered, for example, by the discovery module 41. An “unmapped” device 14 includes a device 14 for which physical links and/or other device characteristics are undetermined and which may have been inferred by the discovery module 41. As described further below, the GUI 48 also is configured to display, in the first window 50, a topology map that includes the mapped devices 14 and a device 14 selected by the user from the second window 52. In one embodiment, if no unmapped devices 14 are discovered, the second window 52 is not displayed.

The GUI 48 provides a point-and-click interface and includes drop down menus 54 and a tool bar 56. The GUI 48 includes a tree list panel 58. The tree list panel 58 displays a tree containing the available SANs 12 and devices 14 associated with the SANs. The first or upper window 50 has a display area 60 in which are graphically depicted physically linked devices 14 and their physical links. Devices 14 having undetermined links and/or inferred links are graphically depicted in a display area 62 in the second or lower window 52. Each of the windows 50 and 52 can be activated separately by the user and can function independently of the other window. The windows 50 and 52 share a map toolbar 64. Actions initiated via the toolbar 64 are associated with the window currently selected by the user. The user selects a window by clicking a left mouse button while a mouse cursor is in the bounds of the window being selected. By default, when the panel 58 is initially displayed, the top window 50 is selected.

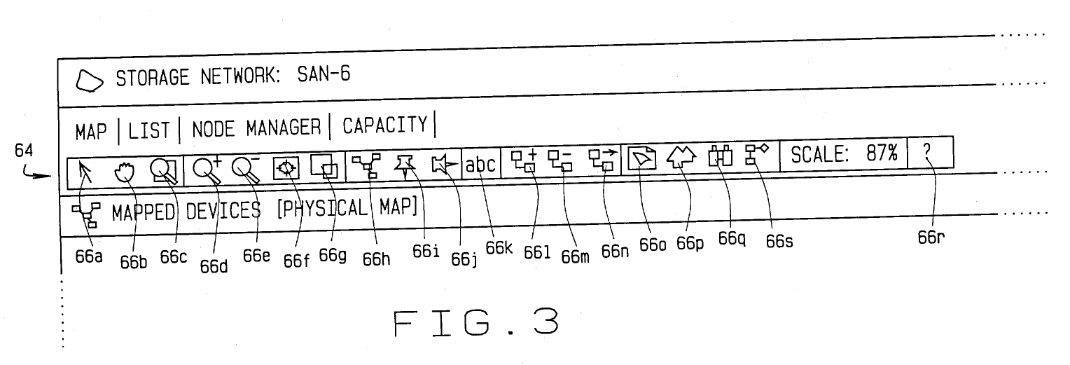

The map toolbar 64, shown in greater detail in FIG. 3, includes a plurality of tool icons 66. The tool icons 66 provide functionality to manipulate a map in the currently selected window 50 or 52. Selecting an icon 66a using the mouse and the cursor changes a current mouse mode to a pointer mode. The icon 66a allows selections to be made within the current window 50 or 52. In one embodiment, only selected map nodes can be moved with the mouse. Selecting a second icon 66b changes a current map mode to a window pan mode. The icon 66b allows an entire map to be moved within the current window 50 or 52. This feature can be used, for example, to center desired device(s) or node(s) in the current window 50 or 52.

Selecting an icon 66c allows an operator to draw a rectangle around objects to be displayed in a viewable region. The rectangle is zoomed such that any nodes outside the rectangle are no longer visible. Selecting icons 66d and 66e allows the operator to zoom into or out of the viewable region. The icons 66d and 66e can be selected repeatedly until upper and lower zoom limits are reached. Selecting an icon 66f automatically scales a map to allow all objects to be viewed within a viewable region.

Selecting an icon 66g displays a sub-window with all map objects, as further described below. Selecting an icon 66h re-draws a display in window 50 using a currently selected layout manager. As a result, all map objects will be in view. Selecting an icon 66i pins a selected node, or all nodes if none selected, to a map in the upper window 50. Pinning affixes the selected node to the map surface and prevent re-layouts from affecting the position of the node. Selecting an icon 66j un-pins a selected node, or all nodes if none is selected, from the map in window 50. The node is thus detached from the map surface, allowing re-layouts to adjust the position of the node. Selecting an icon 66k shows or hides node labels on the map. When selected, the icon 66k appears depressed.

Selecting an icon 661 allows the operator to add links to a map in the window 50. Selecting an icon 66m allows the operator to remove links from a map in the currently selected window 50 or 52. Selecting an icon 66n allows the operator to move links. The icons 661, 66m and/or 66n can be enabled, for example, after one or two nodes have been selected in the window 50.

Selecting an icon 66o presents a layout manager dialog box further described below. Selecting an icon 66p presents a map legend sub-window further described below. Selecting an icon 66q presents a “find node” dialog box, also further described below. Selecting an icon 66r presents a map-level help screen. Toggling an icon 66s allows the user to switch between physical map mode, as shown in FIG. 2, and an inferred map mode in which mapped and unmapped devices are displayed in a single window.

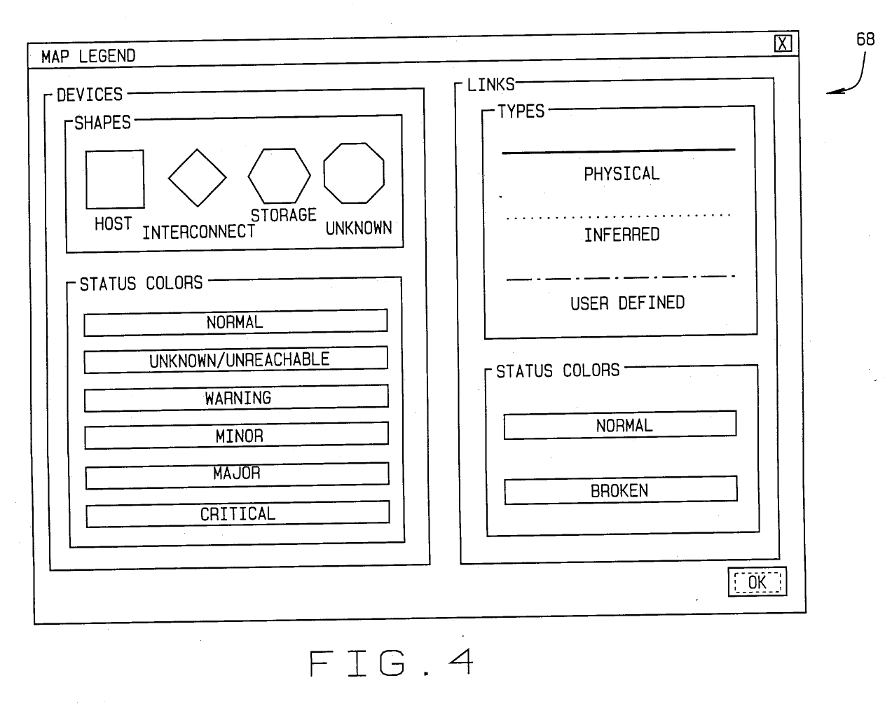

A map legend sub-window of the GUI 48 is indicated generally by reference number 68 in FIG. 4. Referring to FIGS. 2 and 4, types of network devices 14 are graphically depicted in the GUI display areas 60 and 62 via icons having different geometric shapes. The different geometric shapes allow the devices 14 to be recognized readily by the user. Various colors can be used to identify the status of SANs 12 and devices 14. Various colors and/or line styles can be used to identify linked sites and the status of links. As can be appreciated, the specific shapes, colors and line styles indicated in FIG. 4 are exemplary only.

As can be seen in FIG. 2, icons 90 for several mapped devices 14 of the given SAN 12 are displayed in the upper window 50. Mapped devices include an interconnect device 70, a storage device 72 and three unknown devices 74. Physical links 76 from the devices 72 and 74 to the interconnect device 70 have been identified and are graphically depicted. In the lower window 52 are displayed icons 90 for several discovered but unmapped devices 14. An interconnect device 80 and two hosts 82 are graphically depicted in the lower display area 62.

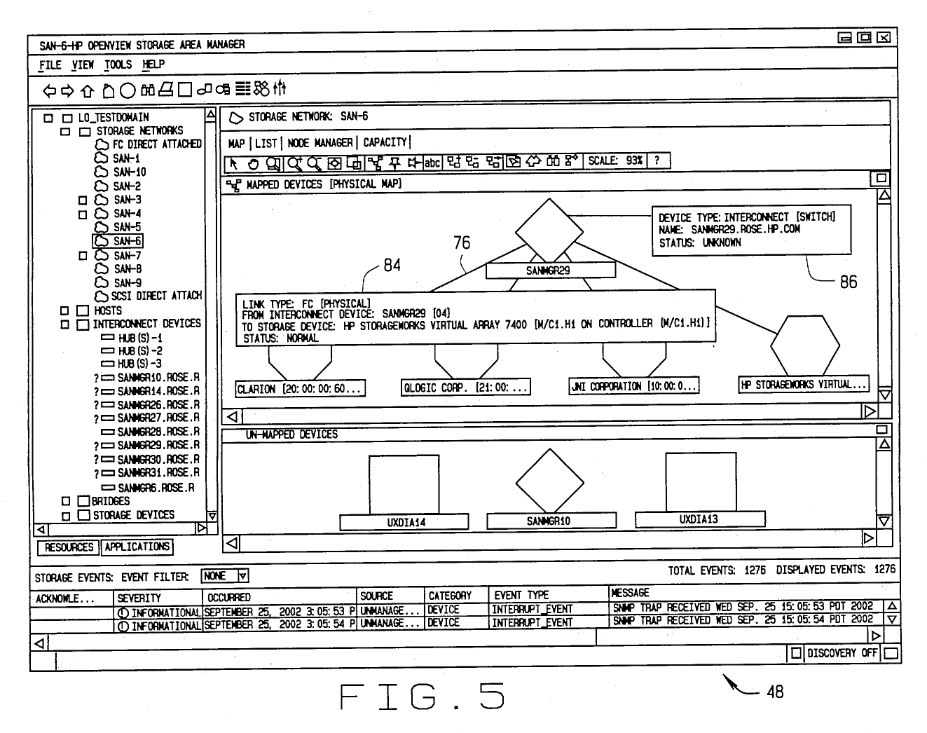

The GUI 48 can provide tooltips to the user that show additional detailed description of links and/or devices in a current window 50 or 52. For example, and referring to FIG. 5, a tooltip 84 is provided when the mouse is positioned over a link 76 for a predetermined period. A second exemplary tooltip 86 is provided when the mouse is positioned over the device 70 for a predetermined period. As can be appreciated, positioning the mouse over a device or a link triggers a pop-up tooltip that shows a more detailed description of the link or device.

For a device 14, one or more of the following are displayed: the physical device type, the specific device type, name of the device, and status of the device. The physical device type includes, for example, host, interconnect, storage, or unknown. The specific device type includes, for example, host operating system version, bridge, hub, disk array, etc.

Additional detailed information provided by the tooltip for a link includes: physical link type, discovery link type, name of the port and the node that the link is coming from, name of the port and the node that the link is going to, and the status of the link. The physical link type includes fibre channel, small computer system interface (SCSI), Ethernet and unknown. The discovery link type includes physical, inferred, and user defined.

After the discovery module 41 has created a SAM 42 in which at least one device 14 is mapped in the upper window 50, the SAM module 44 provides tools to allow the operator to modify the SAM 42 in window 50. As described previously, the tool icons 66 allow the user to change the layout and appearance of the map via such functions such as zoom, layout, pan, etc. Several tools change the topology of the map. Thus a user can add a link between two devices, remove a link between two devices, move an existing link (e.g., remove and add a link in one step), and allow a discovered device to be associated with an inferred interconnect device or with an unknown device. Network topology can be inferred, for example, as described in co-pending U.S. patent application Ser. No. 10/060,633 entitled Method and Apparatus For Inferring Topology Of a Network, filed Jan. 30, 2002, the disclosure of which is incorporated herein by reference.

A user can activate changes to a topology shown in the upper window 50 in different ways, depending on the change desired. The management apparatus 10 assigns a relationship between a device in window 50 and a device in window 52 when initiated by a user of the GUI 48. For example, the user can modify a map displayed in the window 50 by dragging icons 90 of devices 14 from the lower window 52 to the upper window 50 so as to add a link between two devices and/or associate a device with another device, as further described below. Several changes can be activated within the window 50. For example, addition, removal and/or moving of a link can be activated.

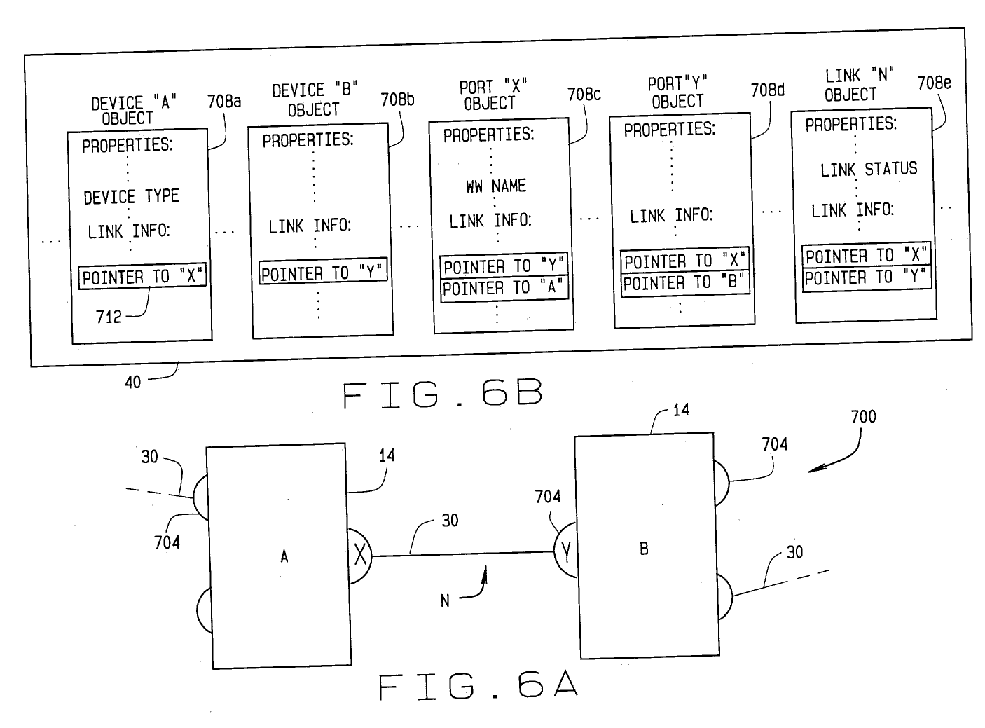

The management apparatus 10 can assign relationships as shall now be described with reference to FIG. 1 and with reference to a map indicated generally by reference number 700 in FIG. 6A. A device “A” has several ports 704, including a port “X”. A device “B” also has several ports 704, including a port “Y”. The two devices “A” and “B” are represented as linked together via the ports “X” and “Y” and a link “N” representing an interconnection 30.

Each device, port and link shown in FIG. 6A is associated with an object 708 of the SAN manager 40, as shown in FIG. 6B. An object 708 includes pertinent property information, e.g., a device type in object 708a for device “A”, a world-wide name in object 708c for port “X”, and a link status in object 708e for the link “N”. An object 708 also includes link information that can be used in building SAN maps. For example, object 708a for device “A” includes a pointer 712 to the device port “X”. Object 708b also has a device port pointer 712, to the port “Y” on device “B”. Object 708c for the device port “X” includes pointers 712 to the parent device “A” and to the connected port “Y”. Object 708d for the device port “Y” includes pointers 712 to the parent device “B” and to the connected port “X”. Object 708e for the link “N” between ports “X” and “Y” includes pointers 712 to the ports “X” and “Y”.

As can be understood from FIGS. 6A and 6B, when a link is added between two devices 14, pointers 712 are added to the objects 708 associated with the device ports 704 for linking the two devices. Pointers 712 to the device ports 704 also are added to an object 708 for the link 30 being added. If, for example, the added link is removed, the pointers 712 are deleted from the objects 708 associated with the device ports 704 that link the two devices. To move the link “N” so as to connect device “A” to another device (not shown), the port pointers 712 are deleted from the port objects 708c and 708d. A new link then is added between device “A” and the other device, as previously described. When two devices 14 are associated, as further described below, port pointers 712 are moved from port objects 708 for one device to port objects 708 for the other device.

There are several ways to add a link between two devices 14. For example, one or two devices 14 can be selected in the upper window 50. A right mouse click on the map background triggers a pop-up menu, from which an “Add Link Between Map Devices” menu item is selected. Alternatively, the icon 661 can be pressed on the map toolbar 64 to initiate adding a link.

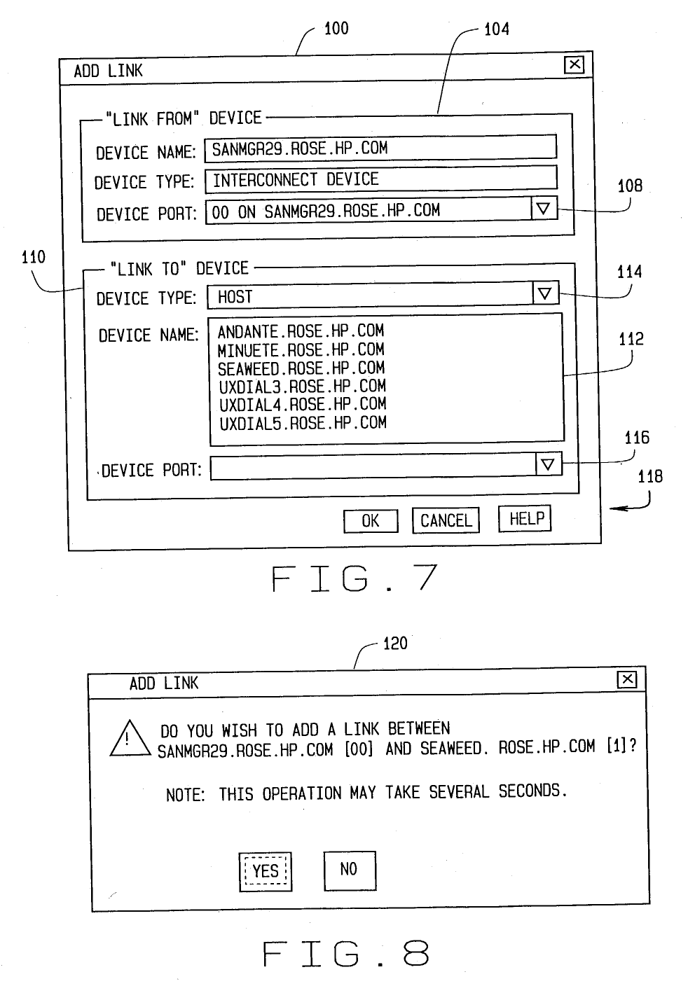

Referring now to FIG. 7, once adding a link is initiated, an add link dialog box 100 is displayed. A “Link From” frame 104 including device name and port is populated with information from the selected device 14. A device port pull down menu 108 is populated with available ports that can be selected. A “Link To” frame 110 including device type and name allows a device to a selected with a corresponding port. To reduce the number of devices 14 displayed in a device name selection box 112, the device type may be specified in a device type pull down menu 114. The device port pull down menu 116 is selected by the operator. If two devices are selected when the add link function is initiated, the device type and device name of the “Link To” frame 110 are populated with the information from the second selected device. The device port pull down menu 116 is selected by the operator.

After a set of selections have been made, the operator can select “OK”, “Cancel” or “Help” command buttons that are generally designated 118. The “Help” command button provides content specific help. Selecting the “Cancel” command button aborts the current add link procedure. Selecting the “OK” command button confirms the add link procedure previously selected and launches a confirmation dialog box 120 shown in FIG. 8. Selecting “Yes” in the dialog box 120 confirms the add link procedure and selecting “No” aborts the add link procedure. If the add link procedure is confirmed, a link is added between the selected devices 14 and displayed in the upper window 50.

If the operator selects a device that is located in a different SAN 12 than the currently selected “Link From” device, the two SANs 12 are linked. This procedure joins the two SANs 12. The SAN 12 with a lower index number is populated with the nodes of the SAN 12 with a higher index number. The SAN 12 with the higher index number will be removed from the current view. Once the add link function is complete, the SAN manager 40 stores the new link information. The discovery process of the discovery module 41 takes the new user-defined information into account as it, e.g., attempts to discover additional devices, links and topologies.

There are several ways to remove a link between two devices 14. For example, one or two devices 14 can be selected in the upper window 50. A right-mouse click on the map background triggers a pop-up menu, from which a “Remove Link” menu item is selected. Alternatively, one or two devices 14 can be selected and the icon 66m is pressed on the map toolbar 64. Another alternative is to right mouse click on the link desired to be removed, thereby triggering the pop-up menu from which the “Remove Link” menu item is selected.

Referring now to FIG. 9, once removing a link is initiated, a remove link dialog box 200 is displayed. A “Link From” frame 202 including device name and type is populated with information from the selected device 14. A device port pull down menu 204 is populated with available ports that can be selected. A “Currently Linked Device” frame 206 is populated with a device name and a selected port based on the device port selected in pull down menu 204. If two devices are selected to initiate the remove link function, or if a link is selected, the device type and device name of the “Currently Linked Device” frame 206 are automatically populated.

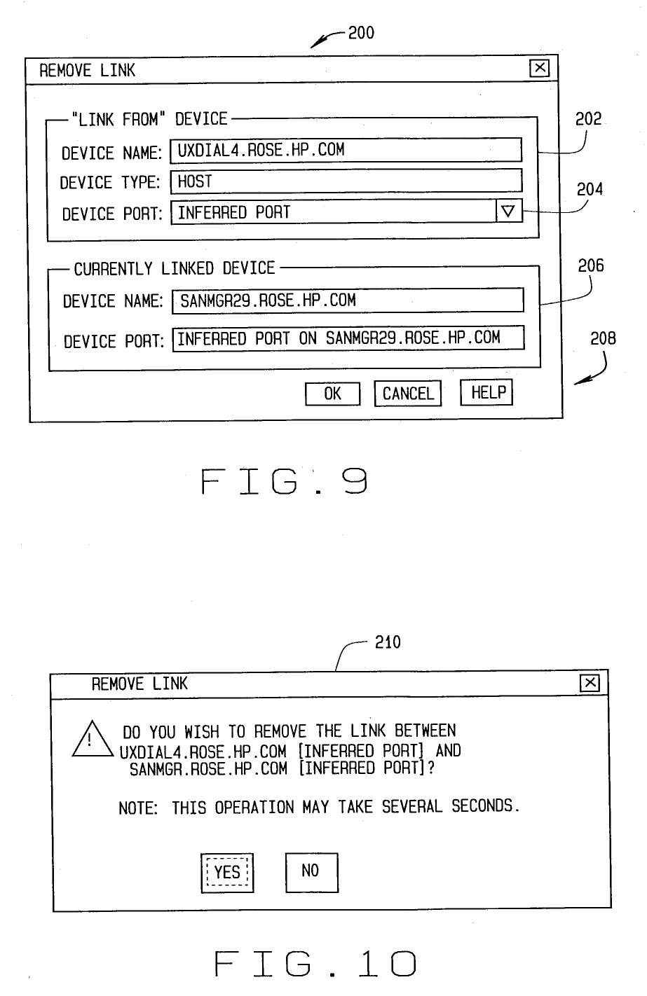

After a set of selections have been made, the operator can select “OK”, “Cancel” or “Help” command buttons that are generally identified at 208. The “Help” command button provides content specific help. Selecting the “Cancel” command button aborts the current remove link procedure. Selecting the “OK” command button confirms the remove link procedure previously selected and launches a confirmation dialog box 210 shown in FIG. 10. If the remove link procedure is confirmed, the link is removed from the map in the upper window 50. As can be appreciated, removing a link may separate a SAN into two SANs. Once the remove link function is complete, the SAN manager 42 stores the new link information. The discovery process of the discovery module 41 takes the new user-defined information into account as it, e.g., attempts to discover additional devices, links and topologies.

Moving a link involves taking an existing link and moving it from one of the linked devices 14 to another device 14. For example, suppose a link is discovered by the SAN manager 42 between devices A and B. Suppose also that an operator knows that the discovered link corresponds to a link actually between the device A and a device C. The operator can remove the link from between A and B and then add the link between A and C in two steps, or the operator can move the link in a single step.

There are several ways to move a link as described above. For example, one or two devices 14 can be selected in the window 50. The operator clicks the right button of the mouse on the map background to trigger the popup menu and selects “Move Link” from the pop-up menu. Alternatively, one or two devices 14 can be selected, and the icon 66n is pressed on the map toolbar 64. Another alternative is to select a link using the right mouse button. The popup menu is thereby activated, and the user selects the “Move Link” menu item from the pop-up menu.

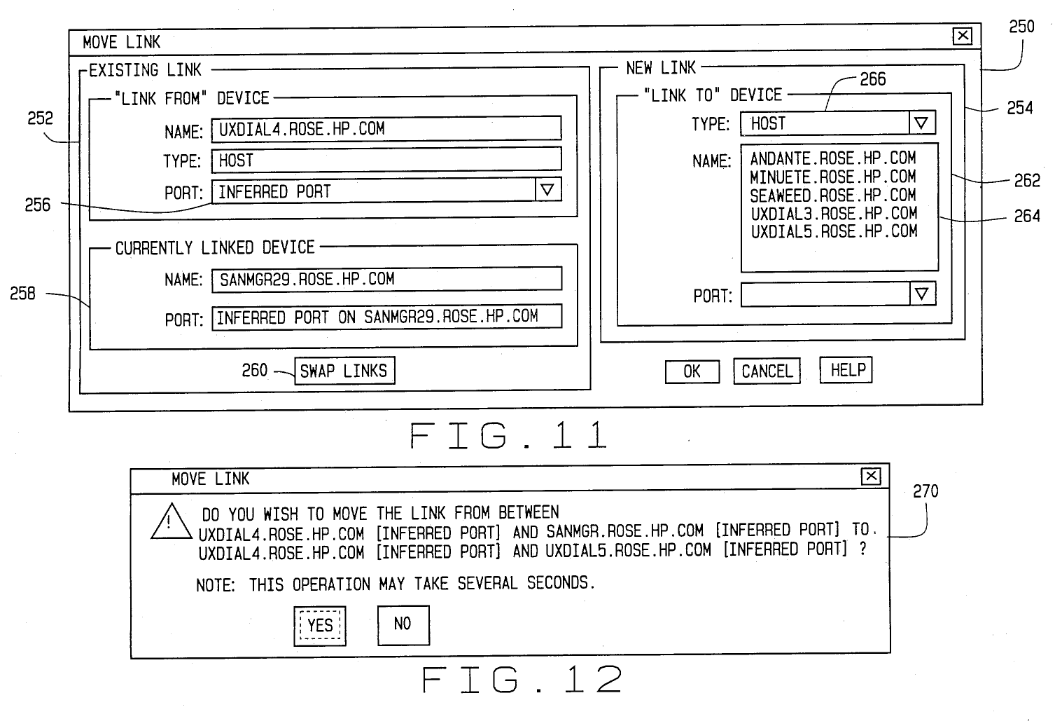

Referring now to FIGS. 11 and 12, once moving a link is initiated, a move link dialog box 250 is displayed. An existing link frame 252 details link information for the current link. A new link frame 254 details link information for the new link. By changing a “Link From” port selection 256, a “Currently Linked Device” section 258 is populated automatically. A “Swap Links” button 260 swaps the “Link From” device information with the “Currently Linked Device”. The button 260 allows the user to specify which device on the “Existing Link” side 252 will remain.

A “Link To” frame 262 allows a device to be selected with a corresponding port. To reduce the number of devices 14 that are displayed in a “Name” selection box 264, the device type may be specified in a device box 266. Selecting the “OK” command button triggers a move link confirmation box 270. Selecting the “Cancel” command button aborts the operation. Selecting the “Help” command button displays content specific help. If the move link procedure is confirmed, the link is moved and displayed in the map in the upper window 50. As can be appreciated, the move link function may join two SANs and/or may separate a SAN into two SANs. Once complete, the SAN manager 42 stores the new link information. The discovery process of the discovery module 41 will take this new information into account as it attempts to discover additional devices, links and topologies.

In the present embodiment, a hub, e.g., a fibre channel hub, can be inferred by the discovery process of the SAN manager 40 when information is not available to determine the exact topology. The inferred hub is indicated by a placeholder device in the tree list panel 58 and also in the map shown in upper window 50. A device for which actual status information is available may also be indicated in the tree 58, but not in the map in window 50. The user can associate such a device with the inferred hub. When the two devices are associated, the SAN manager 40 removes the placeholder device from the tree and replaces the placeholder device in the map with the actual device.

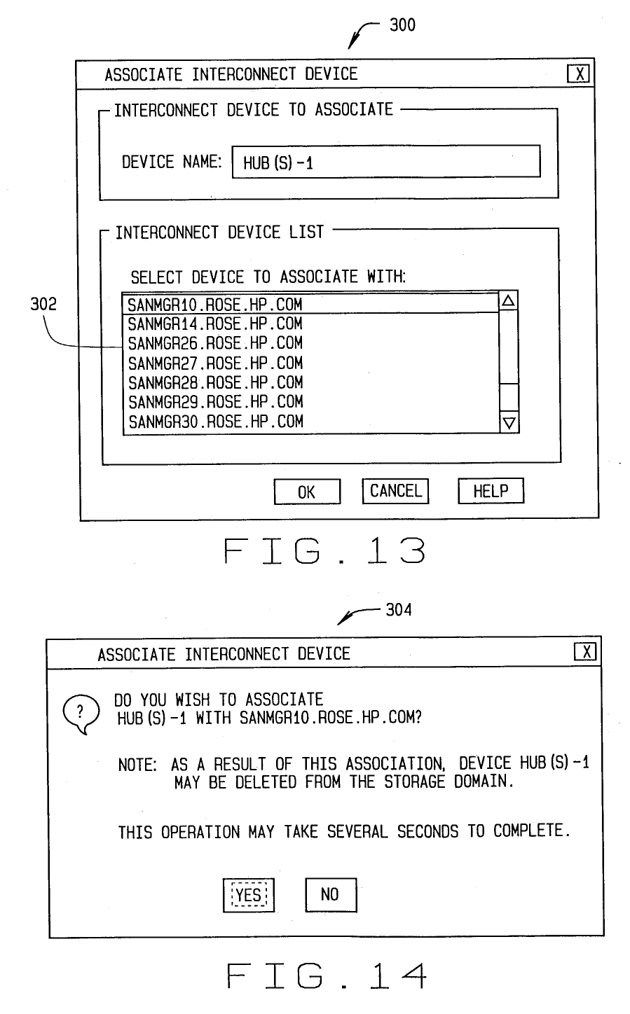

This option is available by right mouse clicking on a desired inferred hub that is listed in the navigation tree to activate the popup menu. An “Associate Interconnect Device” menu item is selected from the pop-up menu. Referring to FIG. 13, an associate interconnect device dialog box 300 is displayed. A list 302 contains names of interconnect devices from which a device to associate with is selected.

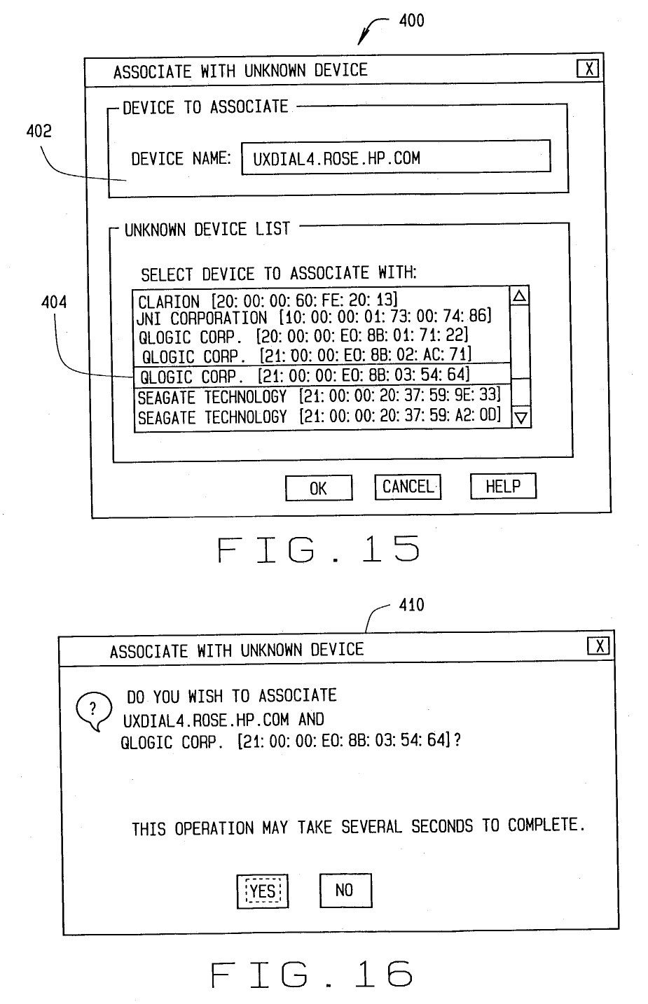

Selecting a device to associate with and pressing the “OK” command button launches an associate interconnect device confirmation box, indicated as 304 in FIG. 14. Selecting “No” aborts the association procedure. Selecting “Yes” causes an association to be created between the selected device and the inferred hub. Once complete, the SAN manager 42 stores and displays the new link information. The discovery process of the discovery module 41 will take this new information into account as it attempts to discover additional devices, links and topologies.

As previously mentioned, a user can use the computer mouse to drag and drop a device icon 90 of an unmapped device 14 from the lower window 52 onto an icon 90 of a mapped device 14 in the upper window 50. Depending on the device types of the devices 14 for which an icon is dragged and an icon is dropped on, the management apparatus 10 performs a corresponding action. Specifically, the apparatus 10 assigns a relationship between the two selected devices. For example, if a user drags an icon 90 for an unmapped host 20 from the lower window 52 onto an icon 90 for a mapped host 20 or a mapped storage device 24, the management apparatus 10 initiates an “Add Link” dialog, which proceeds in the following manner.

Referring to FIGS. 7 and 8, the apparatus 10 displays the add link dialog box 100. The “Link From” frame 104 is populated with a device name and device type for the selected unmapped device 14 for which an icon 90 has been selected and dragged from the lower window 52. In the example shown in FIG. 7, the unmapped device 14 is an interconnect device. The device port pull-down menu 108 is populated with available ports that can be selected. The “Link To” frame 110 is populated with a device type 114 and name 112 for the “dropped on” device. In the example shown in FIG. 7, the mapped device 14 is a host. The device port pull down menu 116 is populated with available ports that can be selected.

When the user has selected port information from menus 108 and 116, the icon 90 for the device 14 previously shown as unmapped in window 52 is displayed in the upper window 50, and a user-defined link is displayed between the dragged and dropped-on icons. Selecting “Yes” in the dialog box 120 confirms the add link procedure and selecting “No” aborts the add link procedure.

If the operator selects a device that is located in a different SAN 12 than the currently selected “Link From” device, the two SANs 12 are linked. This procedure joins the two SANs 12. The SAN 12 with a lower index number is populated with the nodes of the SAN 12 with a higher index number. The SAN 12 with the higher index number will be removed from the current view. Once the add link function is complete, the SAN manager 40 stores the new link information. The discovery process of the discovery module 41 takes the new user-defined information into account as it attempts to discover additional devices, links and topologies.

Depending on the device types of the devices 14 for which an icon is dragged from the window 52 and an icon in window 50 is dropped-on, the management apparatus 10 may associate the devices selected by the user. There are at least two types of device association. For example, where a hub is inferred by the discovery module 41, as described above, the user can select a device to associate with the inferred hub. When the two devices are associated, the SAN manager 40 removes a placeholder device from the tree and replaces the placeholder device in the map with the selected device.

When interconnect device association is initiated by the above described drag-and-drop procedure, the associate interconnect device dialog box 300 is displayed and is populated with device information for the two selected devices 14. Selecting “Yes” in the associate interconnect device confirmation box 304 causes an association to be created between the selected device and the inferred hub as previously described. Once complete, the SAN manager 42 stores and displays the new association information. The discovery process of the discovery module 41 will take this new information into account as it attempts to discover additional devices, links and topologies.

Another type of device association shall now be described. The discovery module 41 may discover a device for which little information is known and which is attached, for example, to a hub. The device (called an “unknown device” herein) can be mapped in window 50 since it is attached to a hub. An unmapped device may be discovered, for example, for which information is known but is insufficient for mapping the device in the window 50. If, for example, a user knows that in reality the unknown and unmapped devices are the same device, the user may associate the unmapped device with the unknown device.

The user can associate an unmapped device in the window 52 with an unknown device shown in window 50. If the user drags an icon 90 for an unmapped device from the lower window 52 onto an icon 90 for an unknown device, the management apparatus 10 initiates an “Associate with Unknown Device” dialog, which proceeds in the following manner. Referring now to FIG. 15, an associate unknown device dialog box 400 is displayed. The devices to be associated are automatically listed in areas 402 and 404 of the dialog box 400. Pressing the “OK” command button launches an associate unknown device confirmation box 410.

Pressing “Yes” causes an association to be created between the devices shown. Specifically, a representation is created, in a memory of the computer 16, that the unknown and unmapped devices are the same device. The unmapped device is no longer shown in window 52, and the information associated with it is attributed to the (previously) unknown device in window 50. Once complete, the SAN manager 42 stores the new association information. The discovery process of the discovery module 41 will take this new information into account as it, e.g., attempts to discover additional devices, links and topologies.

Based on dragged and dropped-on device types selected by the user, the management apparatus 10 performs the following functions shown in Table 1.

TABLE 1

| DRAGGED | DROPPED-ON | |
|---|---|---|
| DEVICE | DEVICE | DEFAULT ACTION |
| Host | Unknown Device | Associate with Unknown Device |
| Host | All other device types | Add Link |
| Switch | Unknown Device | Associate with Unknown Device |
| Switch | Hub | Associate Interconnect Device |
| Switch | All other device types | Add Link |
| Hub | Switch or Hub | Associate Interconnect Device |
| Hub | All other device types | Add Link |
| Storage Device | Unknown Device | Associate with Unknown Device |
| Storage Device | All other device types | Add Link |
| Bridge | Unknown Device | Associate with Unknown Device |
| Bridge | All other device types | Add Link |

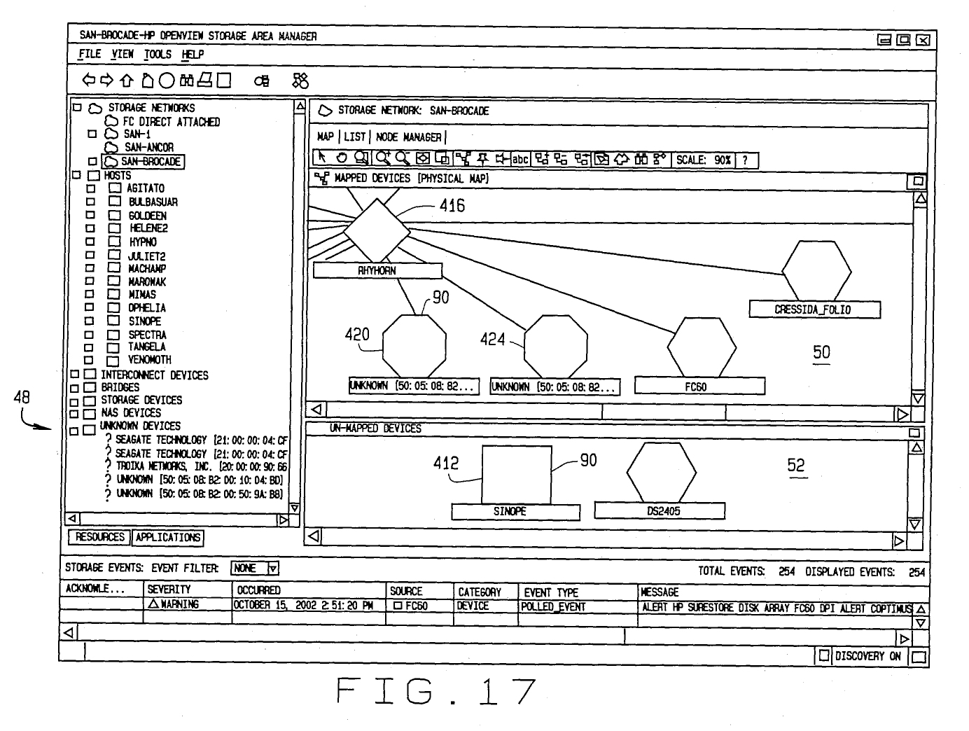

An exemplary sequence of operation using the GUI shall now be described, in which the drag-and-drop operation is used to associate an unmapped device with two unknown devices. As shown in FIG. 17, a host 412, known by a user to have two HBAs (not shown), is displayed by the apparatus 10 as an unmapped device in the lower window 52. The apparatus 10 has discovered that the host 412 can communicate with other SAN devices 14, but the apparatus 10 has insufficient mapping information for mapping the host 412 in the upper window 50. The apparatus 10 also has discovered that an interconnect device 416 is connected via two ports to devices for which there is insufficient information. The apparatus 10 thus displays in the upper window 50 two unknown devices 420 and 424 connected to the interconnect device 416.

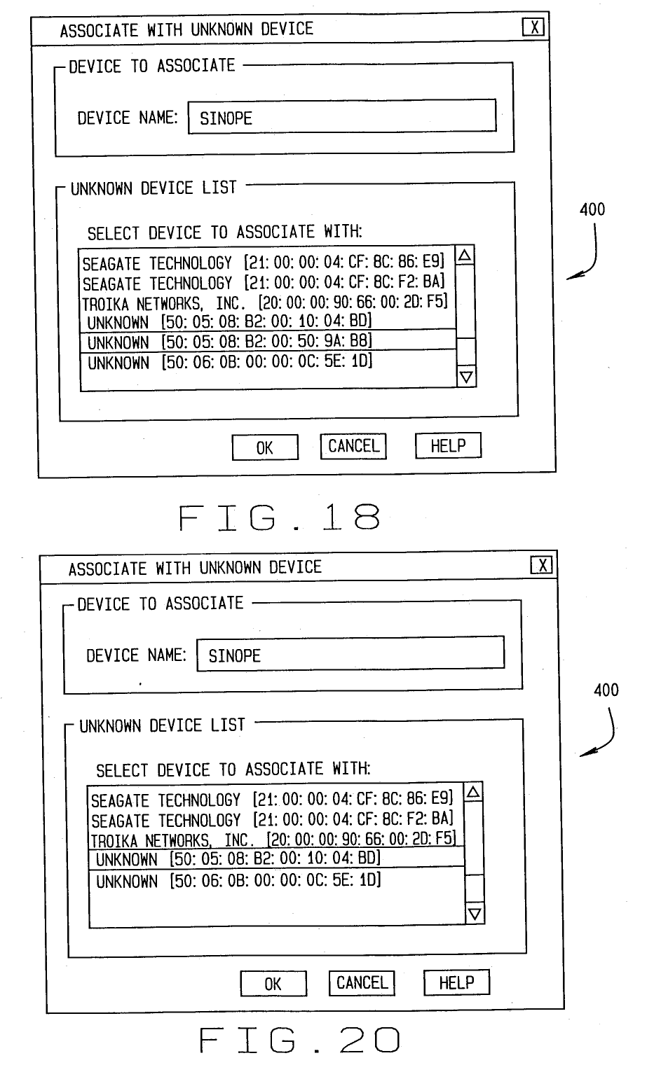

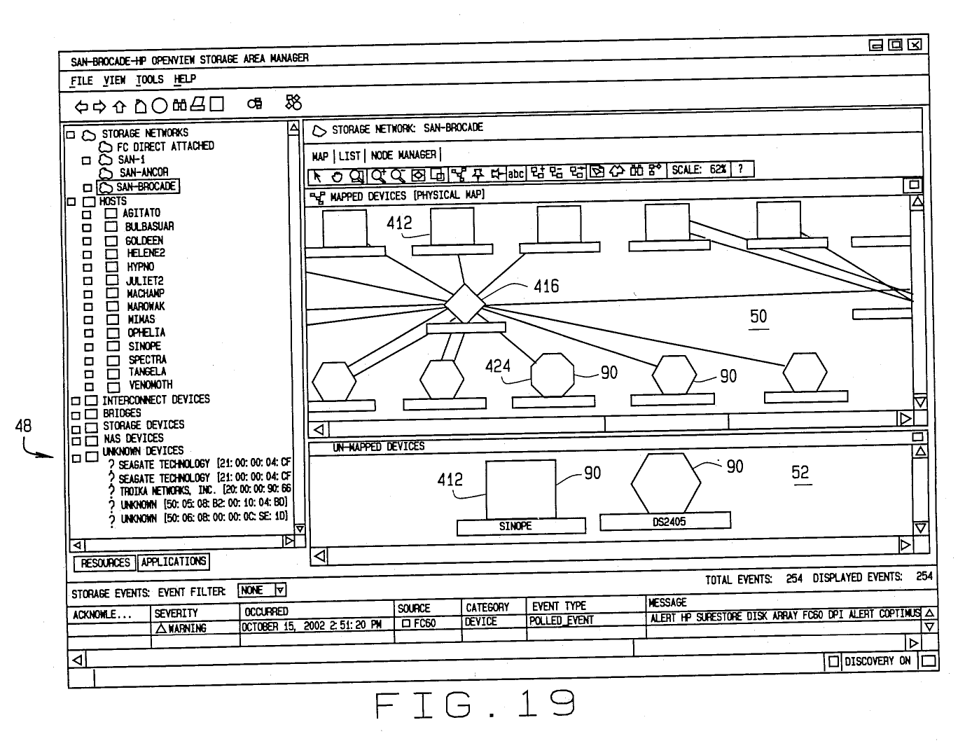

The user drags the icon 90 for the host 412 from the lower window 52 to the upper window 50 and drops it onto the icon 90 for the unknown device 420. The dialog box 400 is displayed and contains information as shown in FIG. 18. The user uses the dialog box 400, as previously described in relation to FIGS. 15 and 16, to associate the host 412 with the unknown device 420. The GUI 48 then appears as shown in FIG. 19. The host 412 has replaced the unknown device 420 in the upper window 50. The host 412 also still appears in the lower window 52, because it has a HBA for which mapping information still is incomplete.

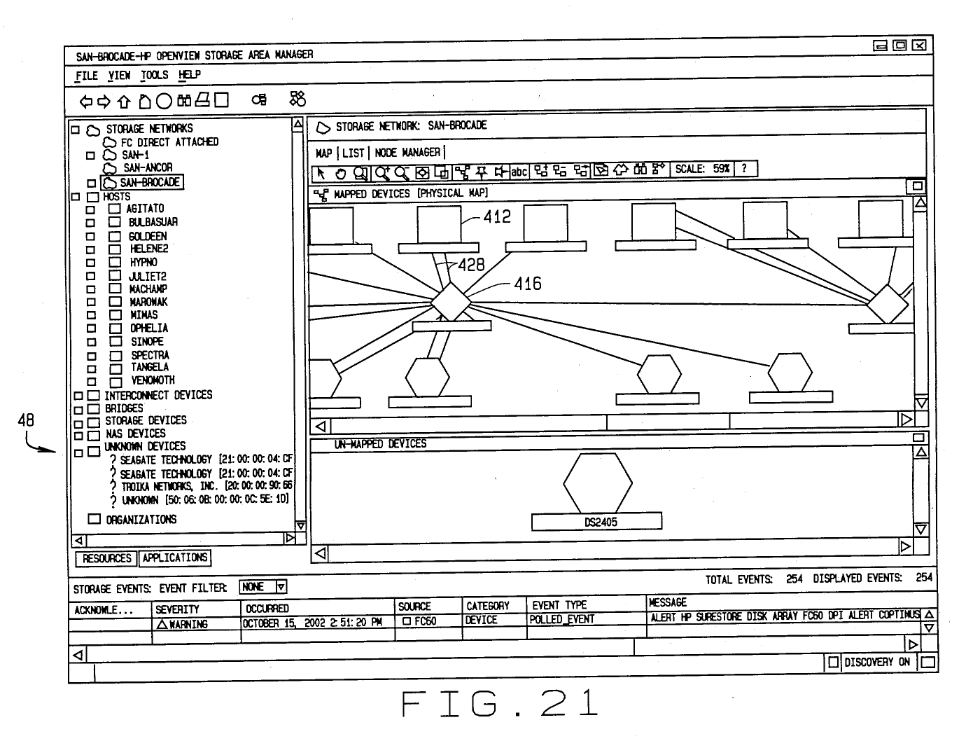

The user drags the icon 90 for the host 412 from the lower window 52 to the upper window 50 and drops it onto the icon 90 for the unknown device 424. The dialog box 400 is displayed and contains information as shown in FIG. 20. The user uses the dialog box 400, as previously described in relation to FIGS. 15 and 16, to associate the host 412 with the unknown device 424. The GUI 48 then appears as shown in FIG. 21. The host 412 has replaced the unknown devices 420 and 424 in the upper window 50, and two links 428 between the host 412 and the interconnect device 416 also are displayed. The host 412 is no longer displayed in the lower window 52.

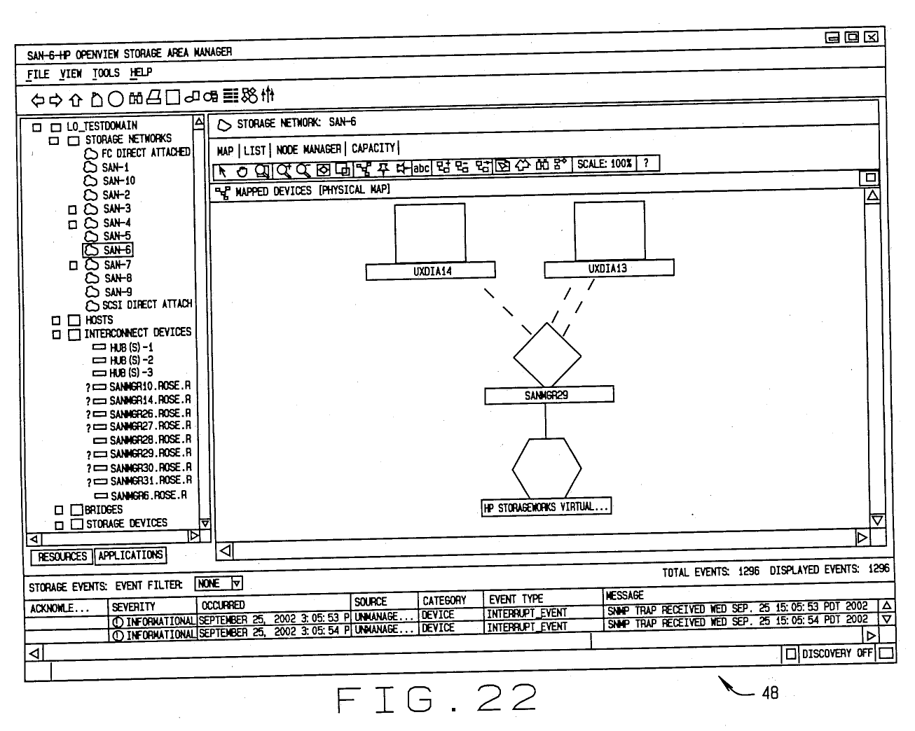

When an operator can supply items of physical information such as port numbers not yet discovered by the discovery module 41, he or she can incrementally build a topology map in the upper window 50 that shows such physical information. The operator can use the GUI 48 to segregate devices 14 having only logical links in the lower window 52. In other situations, a user may wish to view both physical and inferred information on the same topology map. In such event, the user may toggle the icon 66s to switch to inferred map mode as shown in FIG. 22.

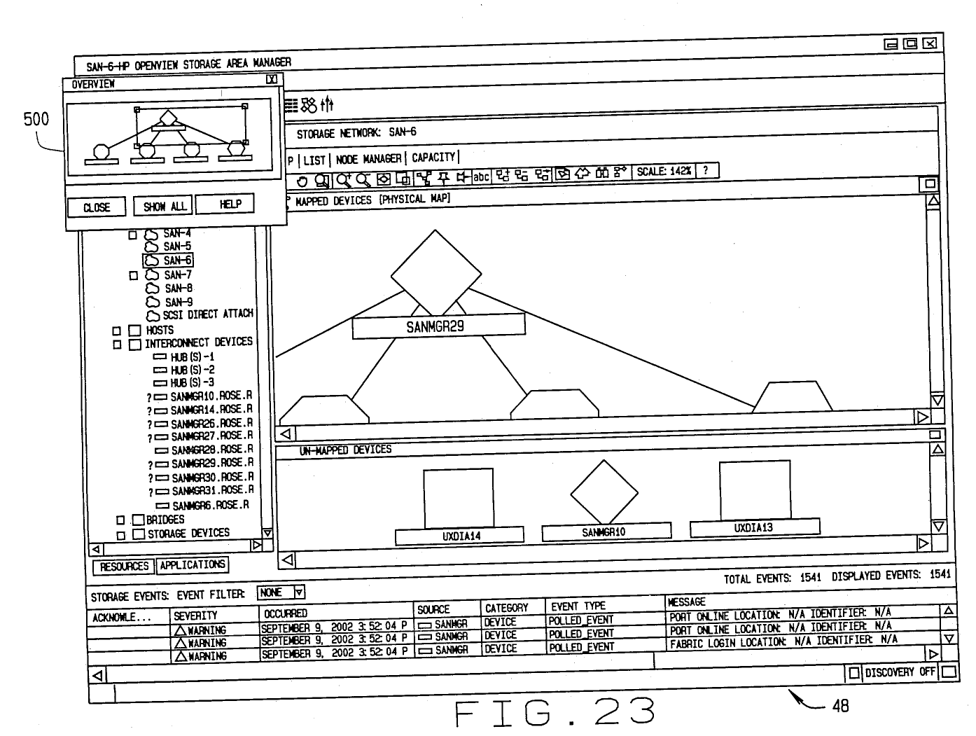

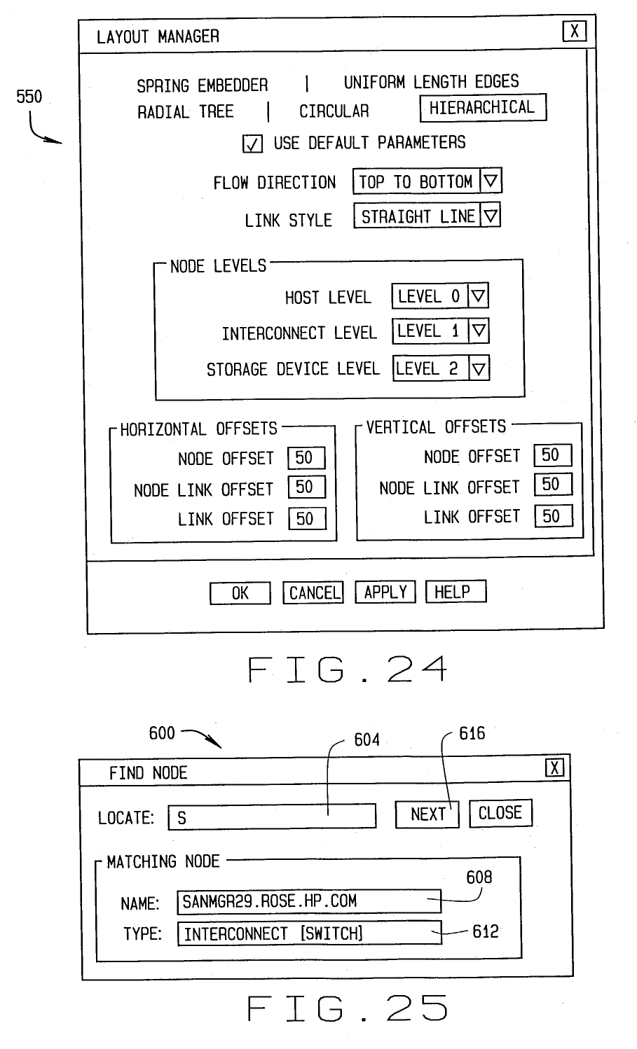

An overview window, indicated in FIG. 23 by reference number 500, is launched using tool icon 66g. From the overview window 500, the operator can drag a rectangle around objects to be displayed in the window 50 or 52. As the rectangle is moved, the contents of the window 50 or 52 change accordingly. A layout dialog box, indicated in FIG. 24 by reference number 550, is launched when a user activates icon 66o. In the present embodiment, the layout manager dialog box 550 can be used to determine how nodes are laid out on a map in the currently selected window 50. Nodes in the bottom window 52 are laid out in a left-to-right grid pattern. A find node dialog box, indicated in FIG. 25 by reference number 600, can be activated in a currently selected window 50 or 52 using icon 66q. As a user types one or more characters into a locate box 604, a search is performed on names of devices in the currently selected window. The first of any matching names is displayed in a name box 608, and information pertaining to the device is displayed in a type box 612. The user can use a “Next” button 616 to display information pertaining to any additional matching names.

The above described management apparatus and methods allow a network administrator using the GUI to view a topology map that shows physically linked devices in one window. Because devices for which physical links have not been determined are shown in an adjacent window, it is easy for the user to quickly distinguish between mapped and unmapped devices. The administrator can supplement the map selectively and incrementally, using inferred link information and/or user-supplied information to include additional devices in the map. The apparatus provides prompt feedback as to how many devices still need to be mapped.

Displaying mapped and unmapped devices in separate windows allows the display area in one window to be manipulated, for example, by dragging, re-laying out, and/or zooming in and out, while the display area in the other window remains static. The separation of devices into two windows is particularly useful when displaying a network having relatively many mapped devices and relatively few unmapped devices. If such a network were shown in a single window, before a user could perform a “drag and drop” operation, he or she might have to attempt to move device icons around in the window to relocate two desired icons close enough to each other to allow the “drag and drop” operation. In the present embodiment, however, because each window operates separately, the user can zoom in on mapped devices in the upper window without pushing unmapped devices in the lower window out of view.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A computerized method of managing a storage area network (SAN) including a plurality of devices, the SAN further including a SAN manager associated with a storage area mapping (SAM) module that represents the devices and links between the devices, the method comprising:
displaying, in a first window of a graphical user interface (GUI), any mapped devices; and
displaying, in a second window of the GUI, any unmapped devices.

2. The method of claim 1 further comprising displaying the first and second windows adjacent each other.

3. The method of claim 1 further comprising assigning a relationship between a device in the first window and a device in the second window, wherein said assigning is initiated by a user using the GUI.

4. The method of claim 3 further comprising using the assigned relationship to discover information for mapping a device in the second window.

5. The method of claim 3 wherein assigning comprises assigning a relationship in response to a user dragging an icon of the device in the second window to an icon of the device in the first window.

6. The method of claim 3 wherein assigning a relationship comprises associating the device in the second window with the device in the first window.

7. The method of claim 6 wherein associating comprises associating with an interconnect device.

8. The method of claim 6 wherein associating comprises associating with an unknown device.

9. The method of claim 3 wherein assigning a relationship comprises linking the device in the second window and the device in the first window.

10. The method of claim 9 wherein linking comprises using port information provided by the user.

11. The method of claim 1 further comprising displaying, in a third window, any mapped and any unmapped devices and any inferred relationships among the devices as determined by a discovery module, wherein said displaying is initiated by a user using a toggle button of the GUI.

12. A computerized method of mapping a storage area network (SAN) including a plurality of devices and links between the devices, the method comprising:
displaying, in a first window of a graphical user interface (GUI), any mapped devices;
displaying, in a second window of the GUI, any unmapped devices; and
inferring a topology that includes a mapped device and an unmapped device selected by a user using the GUI.

13. The method of claim 12 wherein inferring a topology comprises discovering information for mapping a device in the second window based on an assigned relationship between the unmapped device selected by the user and a mapped device.

14. The method of claim 12 further comprising assigning a relationship between mapped and unmapped devices selected by the user.

15. The method of claim 12 further comprising allowing the user to select an unmapped device by dragging an icon of the unmapped device in the second window to an icon of a mapped device in the first window.

16. The method of claim 12 wherein inferring a topology comprises associating the unmapped device selected by the user with a mapped device.

17. The method of claim 12 wherein inferring a topology comprises linking the unmapped device selected by the user and a mapped device.

18. The method of claim 17 wherein linking comprises using port information provided by the user.

19. The method of claim 12 further comprising displaying, in a third window, any mapped and any unmapped devices and any inferred topology, wherein the displaying is initiated by a user using a toggle button of the GUI.

20. A storage area network (SAN) management apparatus comprising a plurality of devices and a computer having a memory, a SAN manager associated with a storage area mapping (SAM) module that represents the devices and links between the devices, and a graphical user interface (GUI) configured to:
display, in a first window, any devices mapped by the SAM module; and
display, in a second window, any unmapped devices.

21. The apparatus of claim 20 wherein the GUI is further configured to display, in the first window, a topology that includes any mapped devices and an unmapped device selected by a user from the second window.

22. The apparatus of claim 20 further comprising a discovery module associated with the SAM module, the discovery module configured to discover information for mapping a device in the second window based on an assigned relationship between the unmapped device selected by the user and a mapped device.

23. The apparatus of claim 20 wherein the GUI is further configured to allow the user to select an unmapped device by dragging an icon of an unmapped device in the second window to the first window.

24. The apparatus of claim 23 wherein the SAM module is further configured to associate the unmapped device selected by the user with a mapped device in the first window.

25. The apparatus of claim 23 wherein the SAM module is further configured to link the unmapped device selected by the user and a mapped device in the first window.

26. The apparatus of claim 25 wherein the SAM module is further configured to link the unmapped device using port information provided by the user via the GUI.

27. The apparatus of claim 20 wherein the GUI is further configured to display, in a third window, any mapped and any unmapped devices and any inferred topology including the devices as determined by a discovery module associated with the SAM module, said display initiated by a user using a toggle button of the GUI.

28. A computer-readable medium comprising computer-executable instructions for:
displaying, in a first window of a graphical user interface (GUI), any mapped devices of a storage area network (SAN); and
displaying, in a second window of the GUI, any unmapped devices of the SAN.

29. The medium of claim 28 further comprising computer-executable instructions for displaying the first and second windows adjacent each other.

30. The medium of claim 28 further comprising computer-executable instructions for assigning a relationship between a device in the first window and a device in the second window, wherein said assigning is initiated by a user using the GUI.

31. The medium of claim 30 further comprising computer-executable instructions for using the assigned relationship to discover information for mapping a device in the second window.

32. The medium of claim 30 wherein assigning comprises assigning a relationship in response to a user dragging an icon of the device in the second window to an icon of the device in the first window.

33. The medium of claim 30 wherein assigning a relationship comprises associating the device in the second window with the device in the first window.

34. The medium of claim 33 wherein associating comprises associating with an interconnect device.

35. The medium of claim 33 wherein associating comprises associating with an unknown device.

36. The medium of claim 30 wherein assigning a relationship comprises linking the device in the second window and the device in the first window.

37. The medium of claim 36 wherein linking comprises using port information provided by the user.

38. The medium of claim 28 further comprising computer-executable instructions for displaying, in a third window, any mapped and any unmapped devices and any inferred relationships among the devices as determined by a discovery module, wherein said displaying is initiated by a user using a toggle button of the GUI.

39. A system for mapping a storage area network (SAN) having a plurality of devices, the system comprising:
a storage area mapping (SAM) module that maps the devices and links between the devices; and
a graphical user interface (GUI) configured to display any mapped devices in a first window and any unmapped devices in a second window.

40. The system of claim 39 wherein the GUI is further configured to assign a relationship between a mapped device and an unmapped device in response to a drop-and-drag operation operable between the windows by a user.

41. The system of claim 40 wherein configured to assign a relationship between a mapped device and an unmapped device comprises configured to associate an unmapped device with an unknown device.

42. The system of claim 40 wherein configured to assign a relationship between a mapped device and an unmapped device comprises configured to associate an unmapped device with an interconnect device.

43. The system of claim 40 wherein configured to assign a relationship comprises configured to add a link.

44. The system of claim 40 wherein the drop-and-drag operation comprises:
dragging an icon from the second window to the first window; and
dropping the icon in the first window.
